(19) United States
(12) Patent Application Publication
(10) Pub. No.: US 2016/0131768 A1
(43) Pub. Date: May 12, 2016

(54) ISOTROPIC FISSION CHAMBER

(71) Applicant: Brigham Young University, Provo, UT (US)

(72) Inventors: John Bartley CZIRR, Mapleton, UT (US); John Ernest ELLSWORTH, Sandy, UT (US); Lawrence Brent REES, Salem, UT (US)

(21) Appl. No.: 14/939,969

(22) Filed: Nov. 12, 2015

Related U.S. Application Data
(60) Provisional application No. 62/078,525, filed on Nov. 12, 2014.

(51) Int. Cl. G01T 1/20; B29C 39/12; B29C 39/02

(52) U.S. Cl. CPC G01T 1/2002; G01T 1/2018; B29C 39/025; B29C 39/026; B29C 39/123; B29K 2105/0058

(57) ABSTRACT

A scintillator includes an activated scintillator region formed in an isotropic shape and configured to generate isotropic emissions of photons and neutrons resulting from fission, and a non-activated scintillator stop region on a surface of the activated scintillator region.

This application claims priority to and the benefit of U.S. Provisional Patent Application 62/078,525 filed on Nov. 12, 2014, entitled “ISOTROPIC FISSION CHAMBER”, the entire contents of which are incorporated in their entirety herein by reference.

This application is related to a co-pending Patent Cooperation Treaty (PCT) application entitled “ISOTROPIC FISSION CHAMBER”, attorney docket number 0076-025WO1, the entire contents of which are incorporated herein by reference.

### FIELD

Embodiments relate to producing neutrons using an isotropic fission chamber.

### BACKGROUND

Neutrons emitted from a fission chamber can yield biased results because of the structure of the neutron source itself. For example, in currently available fission chambers fissile materials are deposited on metal substrates that interfere with and distort the path of fission fragments creating a directional bias and thereby modifying the behavior of neutrons.

### SUMMARY

In a general aspect, a scintillator includes an activated scintillator region formed in an isotropic shape and configured to generate isotropic emissions of photons and neutrons resulting from fission, and a non-activated scintillator stop region on a surface of the activated scintillator region.

In another general aspect, a method of manufacturing a scintillator includes forming an activated scintillator region in an isotropic shape, the activated scintillator region including a photon and neutron emitting fission material, and forming a non-activated scintillator stop region in contact with the activated scintillator region.

In still another general aspect, a system includes an isotropic fission chamber including a photomultiplier tube, a dome, a scintillator disposed within the dome and a detector system configured to detect charged fission fragments that interact with the scintillator to generate light in the isotropic fission chamber. The scintillator includes an activated scintillator region formed in the shape of a sphere and configured to generate isotropic emissions of photons and neutrons resulting from fission, and a non-activated scintillator stop region on a surface of the activated scintillator region. The dome is configured to redirect emissions from the scintillator toward the photomultiplier tube.

Implementations can include one or more of the following features. For example, the activated scintillator region can be an organic solution of fission material combined with scintillator casting resin. The activated scintillator region can be formed by combining an ionic solution of fission material in a liquid scintillator within a vessel having an isotropic shape. The activated scintillator region can be formed by combining an ionic solution of fission material with ground glass within a vessel having an isotropic shape. The activated scintillator region can include one of a stimulated neutron emitting fission material or a spontaneous neutron emitting fission material.

For example, the non-activated scintillator stop region can be configured to ensure fission fragments emitted in the activated scintillator region are stopped and detected in the scintillator. The scintillator can be enclosed within an optically transparent spherical vessel formed of one of glass or plastic. The isotropic shape can be a sphere having a diameter based on an amount of fission material for a particular rate of neutron production, a ratio of scintillator to fission material to minimize degradation due to radiation damage, and minimize a scattering of neutrons.

For example, the method can include forming an optically transparent spherical vessel, wherein the non-activated scintillator stop region is adhered to the inside of the optically transparent spherical vessel, and combining an organic solution of fission material with a scintillator casting resin, wherein the activated scintillator region is formed by disposing the organic solution of fission material combined with scintillator casting resin to the interior of the optically transparent spherical vessel. For example, the method can include forming an optically transparent spherical vessel, wherein the non-activated scintillator stop region is adhered to the inside of the optically transparent spherical vessel, combining an organic solution of fission material with a liquid scintillator, wherein the activated scintillator region is formed by disposing the organic solution of fission material combined with scintillator casting resin into the optically transparent spherical vessel, and allowing the non-activated scintillator stop region to solidify.

For example, the method can include forming an optically transparent spherical vessel, wherein the non-activated scintillator stop region is adhered to an inside wall of the optically transparent spherical vessel allowing the non-activated scintillator stop region to solidify, combining an organic solution of fission material with a liquid scintillator, wherein the activated scintillator region is formed by disposing the organic solution of fission material combined with liquid scintillator into the optically transparent spherical vessel, and sealing the optically transparent spherical vessel. For example, the method can include forming an optically transparent spherical vessel, wherein forming the non-activated scintillator stop region includes lining the inside of optically transparent spherical vessel with a non-activated layer of solid scintillator, combining an organic solution of fission material with a scintillator casting resin, wherein the activated scintillator region is formed by disposing the organic solution of fission material combined with scintillator casting resin into the optically transparent spherical vessel lined with the non-activated layer of solid scintillator, and allowing the organic solution of fission material to solidify. For example, the method can include forming an optically transparent spherical vessel, wherein the non-activated scintillator stop region and the activated scintillator region are formed inside of the optically transparent spherical vessel, and removing the optically transparent spherical vessel after the non-activated scintillator stop region and the activated scintillator region are formed. For example, the method can include forming a suspension mounting as a wire inserted into the activated scintillator region.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates an isotropic fission chamber according to at least one example embodiment.

FIG. 2 illustrates a cross-sectional view of a scintillator according to at least one example embodiment.

FIG. 3 illustrates a system according to at least one example embodiment.

FIG. 4 illustrates a nuclei undergoing fission according to at least one example embodiment.

FIG. 5 illustrates a system using a fission chamber according to at least one example embodiment.

FIG. 6 illustrates the fission chamber including an isotropic fission chamber according to at least one example embodiment.

FIGS. 7, 8 and 9 illustrate methods for forming a scintillator according to at least one example embodiment.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

While example embodiments may include various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

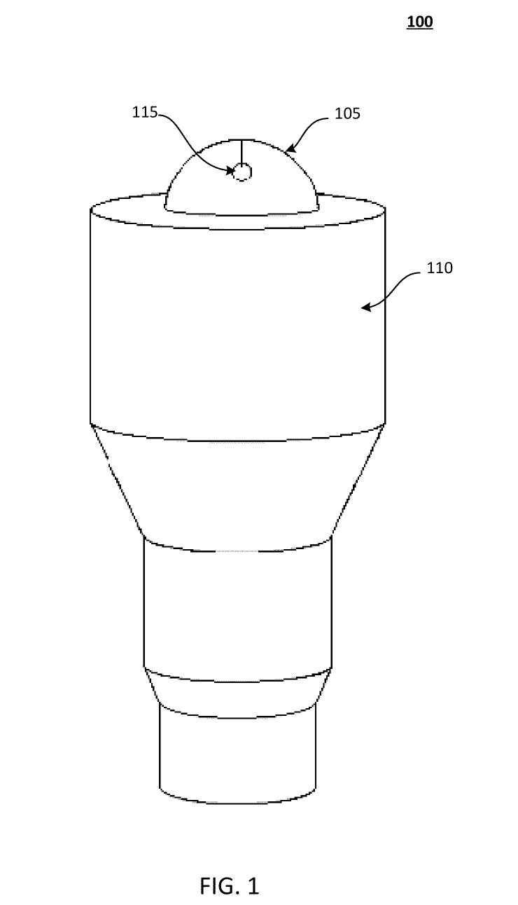

FIG. 1 illustrates an isotropic fission chamber according to at least one example embodiment. As shown in FIG. 1, a fission chamber 100 includes a reflective dome 105, a photomultiplier tube 110 and an activated scintillator 115 (also referred to as scintillator 115). As shown in FIG. 1, the scintillator 115 can be suspended within the reflective dome 105. The scintillator 115 can be formed in an isotropic shape (e.g., a sphere) that results in the scintillator 115 115 emitting particles uniformly or isotropically.

The reflective dome 105 may be configured to redirect emissions (e.g., light emitted) from the scintillator 115 toward the photomultiplier tube 110. The reflective dome 105 may constructed of polished aluminum, aluminized plastic or the like. The reflective dome 105 may have a side (e.g., an inside) layer (e.g., can be coated on the inside) with a spectrally reflective aluminum. The reflective dome 105 may be highly reflective of the wavelengths produced by the scintillator 115. The reflective dome 105 may be shaped as a dome, dome portion, portion of a sphere, hemispherical, parabolic, corner, tent, a hemispherical dome, or other appropriate shapes.

The photomultiplier tube 110 may be configured to convert photons or light into an electrical signal (e.g., as photo electrons). The photomultiplier tube 110 may have an associated gain based on design characteristics (e.g., materials and applied voltages). Accordingly, the photomultiplier tube 110 may also be configured to amplify the electrical signal to a measurable level (e.g., voltage level) by emission of secondary electrons. The reflective dome 105 together with the isotropic shape (e.g., spherical shape) of the activated scintillator 115 can enable the photomultiplier tube 110 to detect omnidirectional or isotropic emissions of photons and thus improve the identification of fission events.

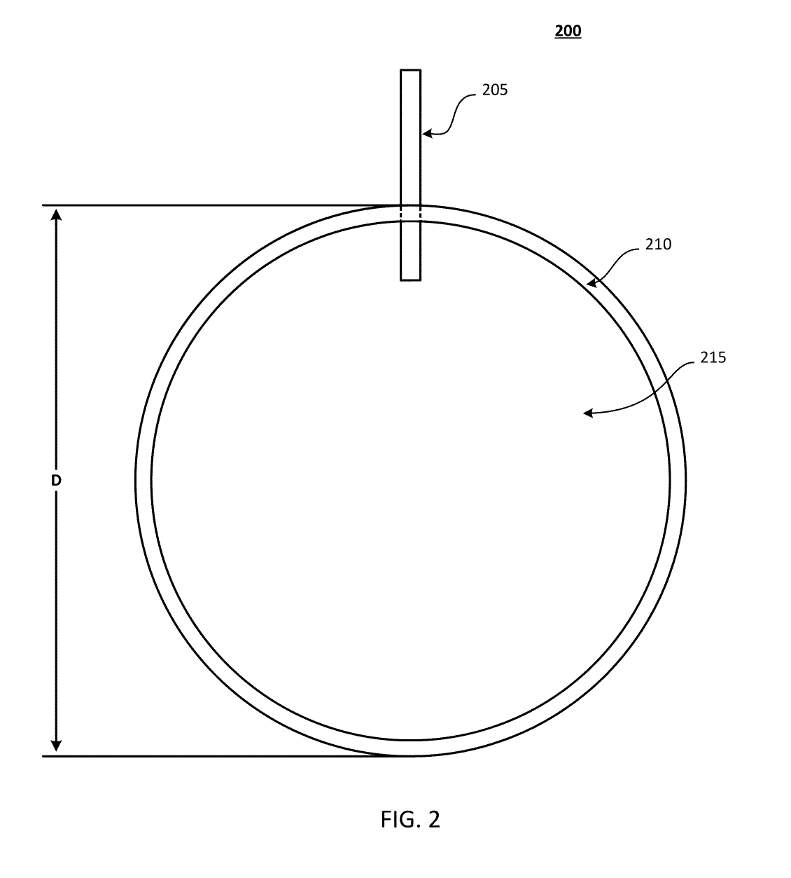

FIG. 2 illustrates a cross-sectional view of a scintillator 200 (e.g., the scintillator 115 of FIG. 1) according to at least one example embodiment. As shown in FIG. 2, the scintillator 200 includes a suspension mounting 205, a non-activated scintillator stop region 210 and an activated region 215 (e.g., activated scintillator region). The scintillator 200 may be configured to emit energy in the form of light having a wavelength compatible with the fissionable material in the activated region 215. For example, the scintillator 200 can operate in a light analysis system having photon level sensitivity, with optics arranged to detect all light produced in both regions 210 and 215 by the scintillator 200. When either nuclear fission or other decay produces charged particles, the scintillator 200 can emit light.

The non-activated scintillator stop region 210 can ensure all (e.g., substantially all, most) fission fragments emitted in the activated region 215 are stopped and detected in the scintillator, preventing the fission fragments from being lost from the scintillator and/or quenched on a container wall. The non-activated stop region 210 may be thin (e.g., a thin wall) as compared to the activated region 215. The non-activated stop region 210 may be formed of one or more layers of non-activated scintillator material. For example, the non-activated stop region 210 may have a thickness in the range of 0.20 mm 0.30 mm. For example, the non-activated stop region 210 may have a thickness of 0.25 mm. However, example embodiments are not limited thereto. For example, other thicknesses and ranges of thicknesses for the non-activated stop region 210 are within the scope of this disclosure.

The scintillator 200 can have a spherical shape. Accordingly, the diameter D of the scintillator 200 can, amongst other considerations, depend on (1) the amount of fission material needed for a particular rate of neutron production, (2) the ratio of scintillator to fission material needed to minimize degradation due to radiation damage, and (3) the need to minimize the scattering of neutrons by the bulk of scintillator.

The isotropic emission of neutrons accompanied by complete detection of all the fission fragments associated with a neutron-producing reaction can be an improvement over existing technologies. This isotropic neutron fission source can be formed by combining (e.g., mixing, compounding, blending, merging, synthesizing and the like) a fission-material with a plastic scintillator, a glass scintillator, a gel scintillator, a liquid scintillator, or the like. The isotropic neutron fission source can then be shaped into an isotropic shape. For example, the isotropic shape can be a sphere or spherical shape or shape approximating a sphere (hemisphere for example). Using the isotropic shaped isotropic neutron fission source can be an improvement because the formed fission source can substantially reduce (or even eliminate) problems associated with undetected fission fragments, which is a characteristic of existing fission chambers using fission materials adhered to a foil or a substrate. The isotropic (e.g., sphere) shaped activated neutron fission source can be encapsulated in a layer (e.g., thin layer as compared to the neutron fission source) of non-activated scintillator, which layer ensures all charged fission products emitted by the radionuclides are detected.

In one example implementation, scintillator 200 may be enclosed within a hollow, thin wall, optically transparent glass vessel (e.g., in the shape of a sphere). The glass vessel may be formed using a glassblowing technique. The non-activated stop region 210 may be formed by applying a thin layer of scintillator casting resin (e.g., Eljen EJ-290) to the interior of the glass vessel, cured to a solid. The activated region 215 can be formed by disposing an organic solution of fission material combining (e.g., mixing, compounding, blending, merging, synthesizing and the like) with scintillator casting resin into the glass vessel. The suspension mounting 205 can be a plastic, glass or metal wire or rod inserted into the glass vessel prior to the resin curing. The suspension mounting 205 can also be a portion of the glass vessel or plastic. When cured, the glass vessel can remain intact or be removed. In other words, the non-activated stop region 210 may be formed of the thin layer of scintillator casting resin by removing (e.g., breaking) the thin wall of the glass vessel. The scintillator 115, 620 is placed in view of the photomultiplier tube 110, 615, away from surfaces, and optimally located to maximize light collection into the photomultiplier tube 110.

In yet another example implementation, activated region 215 may be formed by combining (e.g., mixing, compounding, blending, merging, synthesizing and the like) an ionic solution of fission material with ground glass or ground/powdered Li6 glass (e.g., GS-20 from Applied Scintillation Technologies®, Bicron®, and the like). The liquid portion can be dried. The activated region 215 can be formed by melting and casting the dry mix into a sphere. The fission material and ground glass combination can be formed into a solid isotropic shape (e.g., a sphere). The suspension mounting 205 can be a plastic, glass or metal wire or rod attached to the exterior of the sphere after the mold is removed. The non-activated stop region 210 can be formed by coating the exterior of the sphere with a non-activated scintillator.

In still another example implementation, activated region 215 may be formed by combining (e.g., mixing, compounding, blending, merging, synthesizing and the like) an organic solution of fission material with a liquid scintillator contained in a glass vessel lined with non-activated thin layer of solid scintillator. The glass vessel may be formed using a glassblowing technique.

According to example embodiments, the type of neutron emitting fission material can be either stimulated (uranium, plutonium, or thorium) or spontaneous (also referred to as stimulated neutron emitting fission material or spontaneous neutron emitting fission material). The spontaneous fission materials can be selected from californium, curium, and/or other spontaneously fissioning nuclei. For example, californium has a 2.645 year half-life and 536 Ci/gm activity rate, making it short lived. For example, curium has a 340,000 year half-life and 0.00424 Ci/gr activity rate. Accordingly, curium is long lived (as compared to californium and/or some other materials). However, curium can necessitate the use of more material for the same neutron production rate (as compared to californium and/or some other materials). Curium has the added feature that it has an electron structure (similar to gadolinium) making it colorless in solution.

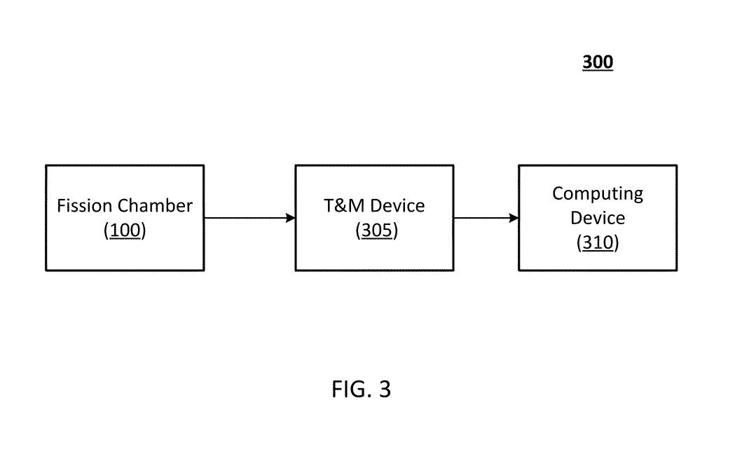

As illustrated in FIG. 3, the output of the photomultiplier tube 110 may be input into a test and measurement device 305 of system 300. For example, the output of the photomultiplier tube 110 may be input into an oscilloscope. The output of the test and measurement device 305 may be input into a computing device 310.

The computing device 310 may be configured to record measurements from the test and measurement device 305, processes the measurements, and generates a display based on the measurements. For example, the display may be a report. The computing device 310 may be configured to control elements of the system 300 (some not shown) For example, the computing device 310 may be configured to control settings associated with the test and measurement device 305 and/or variable settings (e.g., applied voltage) of the photomultiplier tube 110.

The system 300 can include other electronics and the computing device 310 can implement mathematical algorithms and signal processing techniques to identify fission events. Further, the fission chamber 100 can be a standard for calibrating neutron detectors and spectrometers. Still further, in conjunction with other detectors, the fission chamber 100 can form a neutron time-off-light system. This device can provide a more precise start pulse.

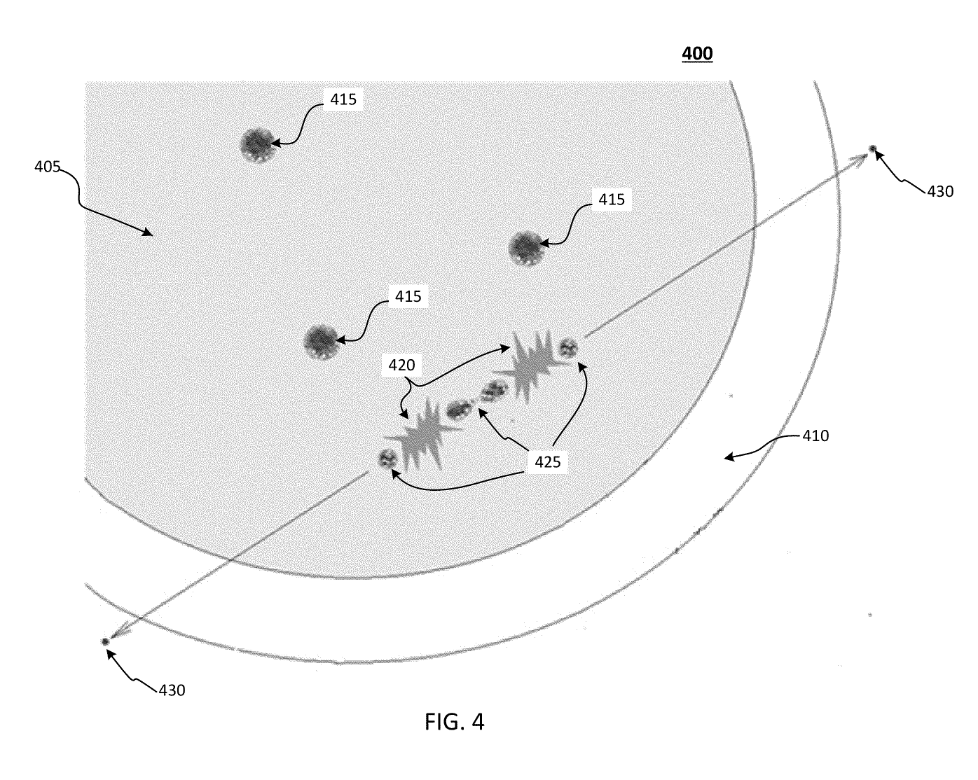

FIG. 4 illustrates a nuclei undergoing fission according to at least one example embodiment. As shown in FIG. 4, a scintillator 400 can include a first scintillator region 405 including fission nuclei 415. The scintillator 400 can also include a second scintillator region 410 that does not include any fission nuclei 415. According to an example embodiment, the fission of a nucleus can result in one or more fission fragments 425 depositing their energy in the scintillator 400. The energy deposited in the scintillator 400 can generate photo emissions 420 (e.g., light), and neutrons 430 can be emitted from the scintillator 400.

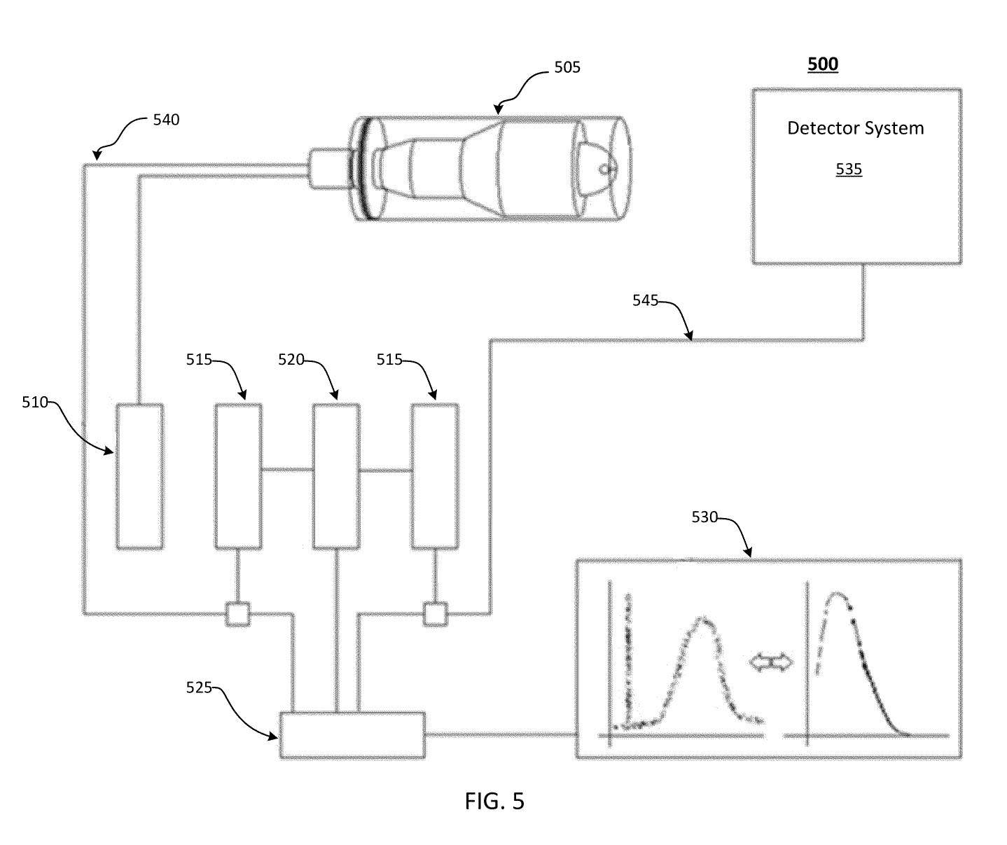

FIG. 5 illustrates a system using a fission chamber according to at least one example embodiment. As shown in FIG. 5, the system 500 can include an isotropic fission chamber 505, a high voltage power supply 510, at least one constant fraction discriminators (CFD) 515, a time converter 520, a high speed digitizer 525, a computing system 530 and a detector system 535. As is further shown in FIG. 5 signals related to the detection of fission that releases neutrons can flow between the isotropic fission chamber 505, the high speed digitizer 525, the detector system 535, and/or the computing system 530. For example, a time of flight (ToF) start signal 540 can be communicated between the high speed digitizer 525 and the isotropic fission chamber 505, and a ToF stop signal 545 can be communicated between the high speed digitizer 525 and the detector system 535. The high voltage power supply 510 can be configured to provide a high voltage in order to power a photomultiplier tube (PMT) of the isotropic fission chamber 505. We detect! It is intended that neutrons escape from this system undisturbed and thereby are undetectable by this system. FYI: the part of the fission process that is

The detector system 535 can be any system used to detect neutrons and/or when neutrons are released from fission events. The detector system 535 can be configured to detect the charged fission fragments that interact with the scintillator to produce light. The uncharged neutrons may not interact sufficiently with the scintillator to allow detection. For example, the detector system 535 can be a detector being calibrated, a detector being characterized (e.g., determining performance attributes), a detector or an array of detectors used in a neutron scattering study, and/or the like. The computing system 530 can be any computing system including, at least, a processor and a memory. The computing system 530 can be configured to record and analyze ToF data. The computing system 530 can further convert the ToF data to corresponding energy spectra. The CFD 515 can be configured to count narrow pulses at very high counting rates, and mark the arrival time of these same pulses.

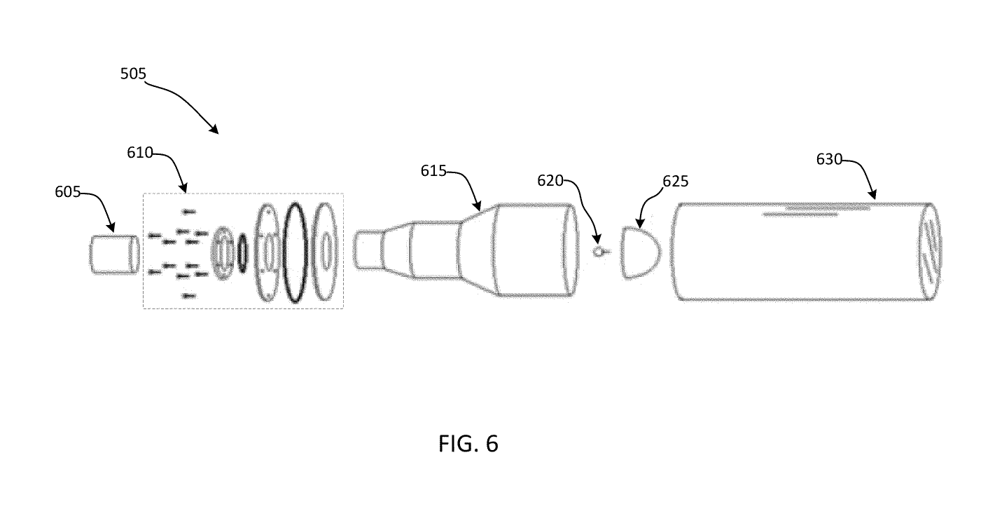

FIG. 6 illustrates the isotropic fission chamber 505 including an isotropic fission chamber according to at least one example embodiment. As shown in FIG. 6, the isotropic fission chamber 505 can include a voltage divider base 605, a gasket seal system 610, a photomultiplier tube 615, an isotropic fission chamber 620 (or scintillator), a dome 625, and a faraday cage light tight enclosure 630.

The voltage divider base 605 can be configured to couple the output of the high voltage power supply 510 (e.g., a high voltage) to the photomultiplier tube 615. The gasket seal system 610 can be configured complete a faraday cage and provide a seal for a light tight enclosure.

The photomultiplier tube 615 can be configured to convert photons or light into an electrical signal (e.g., as photo electrons). The photomultiplier tube 615 may have an associated gain based on design characteristics (e.g., materials and applied voltages). Accordingly, the photomultiplier tube 615 may also be configured to amplify the electrical signal to a measurable level (e.g., voltage level) by emission of secondary electrons.

The dome 625 (or reflective dome) can be configured to redirect or reflect light emitted from the isotropic fission chamber 620 toward the photomultiplier tube 615. The dome 625 together with the spherical shape of the isotropic fission chamber 620 can enable the photomultiplier tube 615 to detect omnidirectional or isotropic emissions of photons and thus improve the identification of fission events.

The faraday cage light tight enclosure 630 can be configured to shield the photomultiplier tube 615 form external light and external electrical interference. The enclosure also blocks electromagnetic emission from the photomultiplier tube 615. The isotropic fission chamber 620 can be configured to can be configured to emit neutrons from the system and produce light in coincidence with the fission reaction producing the emitted neutrons.

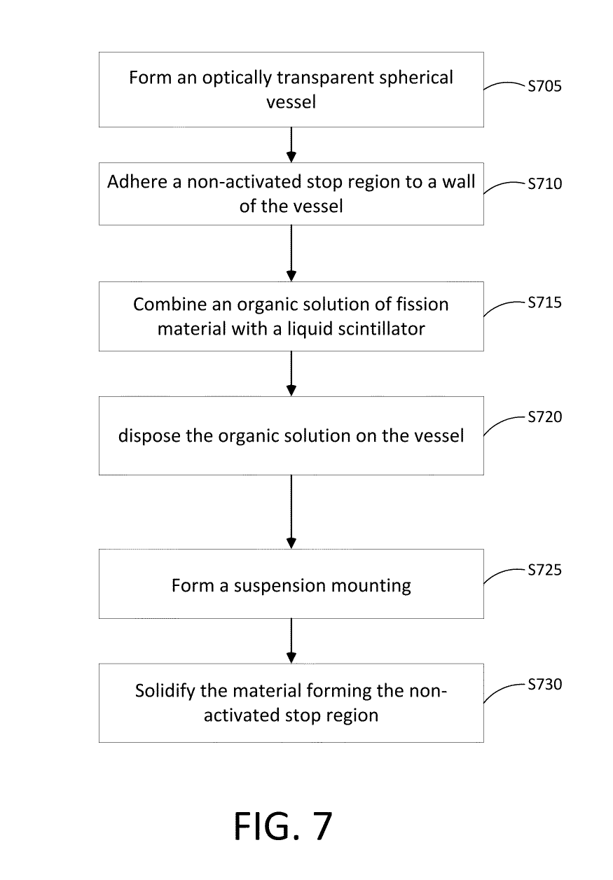

FIGS. 7, 8 and 9 illustrate methods for forming a scintillator (e.g., scintillator 200) according to at least one example embodiment. As shown in FIG. 7, in step S705 an optically transparent spherical vessel is formed. The optically transparent spherical vessel can be formed of one of glass or plastic. For example, the optically transparent spherical vessel may be formed of glass using a glassblowing technique. For example, the optically transparent spherical vessel may be formed of plastic using a mold. In step S710 a non-activated stop region is adhered to the inside or an inside wall of the vessel. For example, the non-activated stop region can be adhered to the wall (e.g., inner surface) of the vessel using a thin layer of scintillator casting resin (e.g., Eljen EJ-290) applied to a surface (e.g., inner surface) of the vessel. In step S715, an organic solution of fission material is combined (e.g., mixed, compounded, blended, merged, synthesized and the like) with a scintillator casting resin. In step S720 the activated region is formed by disposing the organic solution of fission material combined with scintillator casting resin into the vessel lined with the non-activated stop region.

In step S725 a suspension mounting is formed. For example, the suspension mounting can be a plastic, glass or metal wire or rod inserted into (or coupled to) the spherical vessel and the activated region prior to the scintillator casting resin curing. Alternatively, or in addition to, the suspension mounting can be a portion of the spherical vessel. Therefore, the suspension mounting may be formed of glass or plastic. In step S730, the material forming the non-activated stop region is solidified. For example, the scintillator casting resin can cure (or harden) over a period of time in, for example, a curing oven or left in an open environment. In some example implementations, the spherical vessel can be rotated to allow the organic solution to evenly distribute within the spherical vessel during curing. When the scintillator casting resin is solidified (e.g., cured or hardened), the optically transparent sphere can remain intact or be removed. In other words, the non-activated stop region can be formed of the thin layer of scintillator casting resin by removing (e.g., breaking) the thin wall of the optically transparent (e.g., glass or plastic) sphere.

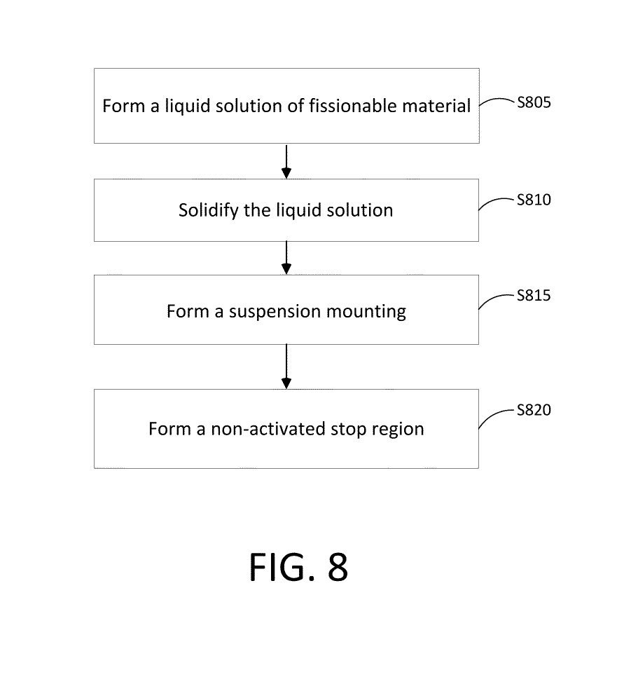

As shown in FIG. 8, in step S805 a liquid solution of fissionable material is formed. For example, the fissionable material may be formed by combining (e.g., mixing, compounding, blending, merging, synthesizing and the like) an ionic solution of fission material with ground/powdered Li6 glass (e.g., GS-20 from Applied Scintillation Technologies®, Bicron®, and the like). In step S810 the liquid solution is solidified (e.g., dried). For example, the liquid solution is dried in an oven or left to air dry. In step S815, the solid solution is cast into a sphere. For example, the solid solution can be melted and cast into a sphere to form the activated region 215. In step S815 a suspension mounting is formed. For example, the suspension mounting 205 can be a plastic, glass or metal wire or rod attached or coupled to the exterior of the sphere after the mold is removed. In step S820 a non-activated stop region is formed. For example, the non-activated stop region 210 can be formed by coating the exterior of the sphere with a non-activated scintillator.

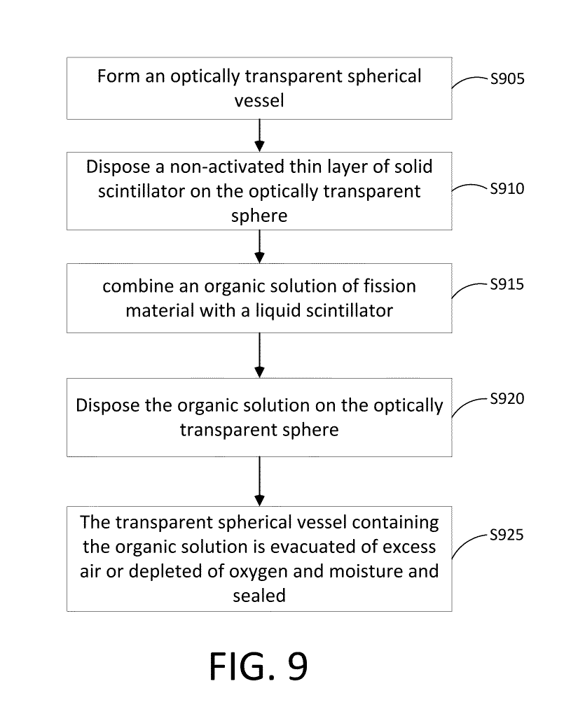

As shown in FIG. 9, in step S905 an optically transparent spherical vessel is formed. For example, the optically transparent sphere may be formed of glass using a glassblowing technique. For example, the optically transparent spherical vessel may be formed of plastic using a mold. In step S910 the non-activated layer of solid scintillator is disposed on the inside surface of the optically transparent spherical vessel and hardened. For example, the non-activated thin layer of solid scintillator may form the non-activated scintillator stop region 210. In step S915 an organic solution of fission material is combined with a liquid scintillator. In step S920 the organic solution is disposed in (e.g., poured into) the optically transparent spherical vessel lined with the non-activated thin layer (e.g., as compared to the active region) of solid scintillator. Alternatively, the organic solution of fission material is combined with a liquid scintillator in the optically transparent spherical vessel lined with the non-activated thin layer of solid scintillator.

In step S925 the optically transparent spherical vessel containing the organic solution is evacuated of excess air or depleted of oxygen and moisture and sealed.

Illustrative applications for the fission chamber are in 1) neutron scattering studies where user's detectors or array of detectors are used and 2) detector characterization or calibration testing.

Some of the above example embodiments are described as processes or methods depicted as flowcharts and/or flow diagrams. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. Example embodiments, however, can be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular embodiments only and is not intended to be limiting of example embodiments. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

The descriptions and representations herein are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A scintillator comprising:
an activated scintillator region formed in an isotropic shape and configured to generate isotropic emissions of photons and neutrons resulting from fission; and
a non-activated scintillator stop region on a surface of the activated scintillator region.

2. The scintillator of claim 1, wherein the activated scintillator region is an organic solution of fission material combined with scintillator casting resin.

3. The scintillator of claim 1, wherein the activated scintillator region is formed by combining an ionic solution of fission material in a liquid scintillator within a vessel having an isotropic shape.

4. The scintillator of claim 1, wherein the activated scintillator region is formed by combining an ionic solution of fission material with ground glass within a vessel having an isotropic shape.

5. The scintillator of claim 1, wherein the activated scintillator region includes one of a stimulated neutron emitting fission material or a spontaneous neutron emitting fission material.

6. The scintillator of claim 1, wherein the non-activated scintillator stop region is configured to ensure fission fragments emitted in the activated scintillator region are stopped and detected in the scintillator.

7. The scintillator of claim 1, wherein the scintillator is enclosed within an optically transparent spherical vessel formed of one of glass or plastic.

8. The scintillator of claim 1, wherein the isotropic shape is a sphere having a diameter based on an amount of fission material for a particular rate of neutron production, a ratio of scintillator to fission material to minimize degradation due to radiation damage, and minimize a scattering of neutrons.

9. A method of manufacturing a scintillator comprising:
forming an activated scintillator region in an isotropic shape, the activated scintillator region including a photon and neutron emitting fission material; and
forming a non-activated scintillator stop region in contact with the activated scintillator region.

10. The method of claim 9, wherein the activated scintillator region is an organic solution of fission material combined with scintillator casting resin.

11. The method of claim 9, wherein the activated scintillator region is formed by combining an ionic solution of fission material with ground glass formed into a solid isotropic shape.

12. The method of claim 9, wherein the activated scintillator region includes one of a stimulated neutron emitting fission material or a spontaneous neutron emitting fission material.

13. The method of claim 9, further comprising:
forming an optically transparent spherical vessel, wherein the non-activated scintillator stop region is adhered to the inside of the optically transparent spherical vessel; and
combining an organic solution of fission material with a scintillator casting resin, wherein the activated scintillator region is formed by disposing the organic solution of fission material combined with scintillator casting resin to the interior of the optically transparent spherical vessel.

14. The method of claim 9, further comprising:
forming an optically transparent spherical vessel, wherein the non-activated scintillator stop region is adhered to the inside of the optically transparent spherical vessel;
combining an organic solution of fission material with a liquid scintillator, wherein the activated scintillator region is formed by disposing the organic solution of fission material combined with scintillator casting resin into the optically transparent spherical vessel; and
allowing the non-activated scintillator stop region to solidify.

15. The method of claim 9, further comprising:
forming an optically transparent spherical vessel, wherein the non-activated scintillator stop region is adhered to an inside wall of the optically transparent spherical vessel allowing the non-activated scintillator stop region to solidify;
combining an organic solution of fission material with a liquid scintillator, wherein the activated scintillator region is formed by disposing the organic solution of fission material combined with liquid scintillator into the optically transparent spherical vessel; and
sealing the optically transparent spherical vessel.

16. The method of claim 9, further comprising:
forming an optically transparent spherical vessel, wherein forming the non-activated scintillator stop region includes lining the inside of optically transparent spherical vessel with a non-activated layer of solid scintillator;
combining an organic solution of fission material with a scintillator casting resin, wherein the activated scintillator region is formed by disposing the organic solution of fission material combined with scintillator casting resin into the optically transparent spherical vessel lined with the non-activated layer of solid scintillator; and
allowing the organic solution of fission material to solidify.

17. The method of claim 9, further comprising:
forming an optically transparent spherical vessel, wherein the non-activated scintillator stop region and the activated scintillator region are formed inside of the optically transparent spherical vessel; and
removing the optically transparent spherical vessel after the non-activated scintillator stop region and the activated scintillator region are formed.

18. The method of claim 9, further comprising:
forming a suspension mounting as a wire inserted into the activated scintillator region.

19. A system comprising
an isotropic fission chamber including a photomultiplier tube, a dome and a scintillator disposed within the dome, the scintillator including:
an activated scintillator region formed in the shape of a sphere and configured to generate isotropic emissions of photons and neutrons resulting from fission, and
a non-activated scintillator stop region on a surface of the activated scintillator region; and
the dome configured to redirect emissions from the scintillator toward the photomultiplier tube; and
a detector system configured to detect charged fission fragments that interact with the scintillator to generate light in the isotropic fission chamber.

20. The system of claim 19, wherein the non-activated scintillator stop region is configured to ensure the charged fission fragments emitted in the activated scintillator region are stopped and detected in the scintillator.

21. The system of claim 19, wherein the activated scintillator region includes one of a stimulated neutron emitting fission material or a spontaneous neutron emitting fission material.

22. The system of claim 19, wherein the activated scintillator region is an organic solution of fission material combined with scintillator casting resin.

23. The scintillator of claim 19, wherein the activated scintillator region is formed by combining an ionic solution of fission material in a liquid scintillator within a vessel having an isotropic shape.
